(19) United States
(12) Patent Application Publication
(10) Pub. No.: US 2024/0139880 A1
(43) Pub. Date: May 2, 2024

(54) ARC SPOT WELDING METHOD FOR JOINING DISSIMILAR MATERIALS AND WELD JOINT OF DISSIMILAR MATERIALS

(71) Applicant: KABUSHIKI KAISHA KOBE SEIKO SHO (KOBE STEEL, LTD.), Hyogo (JP)

(72) Inventors: Tatsuro OSHIDA, Kanagawa (JP); Masao HADANO, Kanagawa (JP); Yoichiro SHIMODA, Kanagawa (JP); Reiichi SUZUKI, Kanagawa (JP)

(73) Assignee: KABUSHIKI KAISHA KOBE SEIKO SHO (KOBE STEEL, LTD.), Hyogo (JP)

(21) Appl. No.: 18/548,480

(22) PCT Filed: Feb. 14, 2022
(86) PCT No.: PCT/JP2022/005610

§ 371 Date: Aug. 30, 2023

(30) Foreign Application Priority Data
Mar. 5, 2021 (JP) 2021-035718
Jan. 14, 2022 (JP) 2022-004685

(51) Int. Cl. B23K 26/348; B23K 9/007; B23K 9/23; B23K 10/02; B23K 26/32; B23K 26/323

(52) U.S. Cl. CPC B23K 26/348; B23K 9/007; B23K 9/23; B23K 10/022; B23K 26/32; B23K 26/323; B23K 2103/04

(57) ABSTRACT

The arc spot welding method for joining dissimilar materials, in which a first sheet (10) made of an Al-based material or an Mg-based material and a second sheet (20) made of ultra-high tensile steel having a tensile strength of 1180 MPa or more are joined, includes a step of forming a hole in the first sheet (10), a step of overlapping the first sheet (10) and the second sheet (20), a step of inserting a joining auxiliary member (30) made of steel, in which a hollow portion is formed, into the hole of the first sheet (10), and a step of joining the first sheet (10) and the second sheet (20) via the joining auxiliary member (30) using a welding material containing 13 mass % or more of Ni.

### TECHNICAL FIELD

The present invention relates to an arc spot welding method for joining dissimilar materials and a weld joint of dissimilar materials.

### BACKGROUND ART

The transportation equipment represented by an automatic vehicle is continuously required to improve the running fuel efficiency for prevention in various kinds of aspects such as (a) consumption of petroleum fuel which is a finite resource, (b) CO₂ which is a global warming gas generated along with combustion, and (c) running cost. In addition to the improvement in a power system technique such as the use of the electric drive, the reduction in the weight of a vehicle body is also an improvement measure. In order to reduce the weight, a method for replacing steel used as a current main material with an aluminum alloy, a magnesium alloy, a carbon fiber, or the like, which is a lightweight material, is used. However, in order to replace all of the materials with lightweight materials, there is a problem that the cost is increased and the strength is insufficient. As a solution, a design method called a multi-material in which steel and a lightweight material are combined at appropriate positions has attracted attention.

In order to combine the steel and the lightweight material, there is inevitably a portion where the steel and the lightweight material are joined. It is known that welding, which is easy for steels, aluminum alloys, and magnesium alloys, is extremely difficult for dissimilar materials. This is because an intermetallic compound (IMC), which is extremely brittle, is generated in a melt-mixing portion of steel and aluminum or magnesium, and the melt-mixing portion is easily broken by an external stress such as a tensile stress or an impact. Therefore, welding methods such as a resistance spot welding method and an arc welding method cannot be adopted for joining dissimilar materials, and other joining methods are typically used. The welding cannot be used for joining between steel and a carbon fiber since the latter is not a metal.

As an example of a dissimilar material joining technique in the related art, Patent Literature 1 discloses an arc spot welding method in which an upper sheet made of an aluminum alloy or a magnesium alloy and a lower sheet made of steel overlap each other and welded via a joining auxiliary member made of steel. In the arc spot welding method described in Patent Literature 1, the joining auxiliary member having a hollow portion is inserted into a hole provided in the upper sheet, the lower sheet and the joining auxiliary member are welded while the hollow portion is filled with weld metal.

Further, Patent Literature 2 proposes an arc spot welding method for joining dissimilar materials, in which a shape of the joining auxiliary member described in Patent Literature 1 is improved. The joining auxiliary member described in Patent Literature 2 has a stepped outer shape having a shaft portion and a flange portion, a maximum outer diameter of the shaft portion and a width of the flange portion are larger than a diameter of the hole of the upper sheet, and the shaft portion has a necking portion on the flange portion side.

According to the welding methods described in Patent Literatures 1 and 2, a high joining strength and reliability can be obtained since the steels are welded to each other. In addition, according to Patent Literature 2, the maximum outer diameter of the shaft portion is larger than the diameter of the hole of the upper sheet, so that a force for restricting the upper sheet and the lower sheet in the horizontal direction is obtained, and the strength against the shear stress in the horizontal direction can be improved.

### CITATION LIST

### Patent Literature

Patent Literature 1: JP2018-034164A
Patent Literature 2: JP2018-103240A

### SUMMARY OF INVENTION

### Technical Problem

In the case of a weld joint obtained by joining two sheet materials in an overlapping manner, examples of an index for determining a strength of the joint include a tensile shear strength (TSS) and a cross tensile strength (CTS). Therefore, even for a weld joint of dissimilar materials in which the steel and the lightweight material are combined to join the dissimilar materials, both TSS and CTS are required to be excellent.

For example, in the case where a steel sheet of 1180 MPa class or less is used as the lower sheet and dissimilar materials are joined by the welding method described in Patent Literatures 1 and 2, a weld joint having good TSS and CTS can be obtained.

On the other hand, in the field of the transportation equipment and the like, there is

an increasing demand for further increasing the strength of a steel material part, and it is necessary to study the high strengthening of a multi-material using an ultra-high tensile steel material having a content of C (carbon) of 0.1 mass % or more and a tensile strength of 1180 MPa or more (about 1.2 GPa class or more).

However, when aluminum or an aluminum alloy material and ultra-high tensile steel of 1180 MPa or more are welded by the welding method described above, a desired CTS may not be obtained.

The present invention has been made in view of the above problems, and an object of the present invention is to provide an arc spot welding method for joining dissimilar materials, by which dissimilar materials that are a material made of pure aluminum or an aluminum alloy (hereinafter, also referred to as an “Al-based material”) or pure magnesium or a magnesium alloy (hereinafter, also referred to as an “Mg-based material”) and a steel material can be joined using inexpensive arc welding equipment that has already been widely used, and by which a weld joint of dissimilar materials that is excellent in both the tensile shear strength and the cross tensile strength can be obtained, and a weld joint of dissimilar materials that is excellent in both the tensile shear strength and the cross tensile strength.

### Solution to Problem

As a result of intensive studies to solve the above problems, the present inventors have found that the strength of a weld joint of dissimilar materials can be improved by using a welding material containing 13 mass % or more of Ni in the case where a steel material to be welded is ultra-high tensile steel having a tensile strength of 1180 MPa or more.

Therefore, the object of the present invention is achieved by the following configuration (1).

(1) An arc spot welding method for joining dissimilar materials, in which a first sheet made of an Al-based material or an Mg-based material and a second sheet made of ultra-high tensile steel having a tensile strength of 1180 MPa or more are joined, the arc spot welding method including:
a step of forming a hole in the first sheet;
a step of overlapping the first sheet and the second sheet;
a step of inserting a joining auxiliary member made of steel, in which a hollow portion penetrating in a sheet thickness direction of the first sheet and the second sheet is formed, into the hole provided in the first sheet; and
a step of joining the first sheet and the second sheet via the joining auxiliary member by using a welding material containing 13 mass % or more of Ni,
in which the step of joining the first sheet and the second sheet is a step of melting the second sheet and the joining auxiliary member and melting the welding material to fill the hollow portion of the joining auxiliary member with weld metal.

A preferred embodiment of the present invention relating to the arc spot welding method for joining dissimilar materials relates to the following (2) to (4).

(2) The arc spot welding method for joining dissimilar materials according to (1), in which in the step of joining the first sheet and the second sheet, the weld metal is melted into the second sheet until a state where a back bead appears.

(3) The arc spot welding method for joining dissimilar materials according to (1) or (2), in which the joining auxiliary member has a stepped outer shape having an insertion portion and a non-insertion portion, and the hollow portion is formed in a manner of penetrating the insertion portion and the non-insertion portion.

(4) The arc spot welding method for joining dissimilar materials according to any one of (1) to (3), in which in the step of joining the first sheet and the second sheet, any one of the following welding methods (a) to (e) is used:
(a) a gas-shielded arc welding method in which the welding material is used as a wire of a consumable electrode type;
(b) a non-gas arc welding method in which the welding material is used as a wire of a consumable electrode type;
(c) a gas tungsten arc welding method in which the welding material is used as a filler of a non-consumable electrode type;
(d) a plasma arc welding method in which the welding material is used as a filler of a non-consumable electrode type; and
(e) a coated arc welding method in which the welding material is used as a welding electrode of a consumable electrode type.

The object of the present invention is achieved by the following configuration (5) relating to a weld joint of dissimilar materials.

(5) A weld joint of dissimilar materials, which is joined by the arc spot welding method for joining dissimilar materials according to any one of (1) to (4), the weld joint comprising:
a first sheet made of an Al-based material or an Mg-based material;
a second sheet made of ultra-high tensile steel having a tensile strength of 1180 MPa or more; and
a joint portion where the first sheet and the second sheet are joined,
in which the first sheet has a hole facing a surface to overlap the second sheet, and
the joint portion includes
a joining auxiliary member made of steel, the joining auxiliary member being inserted into the hole provided in the first sheet and having a hollow portion penetrating in a direction orthogonal to the overlapping surface, and
a weld metal which includes a part of the joining auxiliary member and a part of the second sheet and with which the hollow portion of the joining auxiliary member is filled.

A preferred embodiment of the present invention relating to the weld joint of dissimilar materials relates to the following (6) and (7).

(6) The weld joint of dissimilar materials according to (5),
in which the second sheet has a heat-affected zone at a position adjacent to the joint portion,
a maximum hardness of the heat-affected zone is 130% or more with respect to an average hardness of an area of the second sheet excluding the heat-affected zone, and
a maximum hardness of the weld metal is 50% or less with respect to the average hardness.

(7) The weld joint of dissimilar materials according to (5) or (6), in which the joining auxiliary member has a stepped outer shape having an insertion portion and a non-insertion portion, and the insertion portion is inserted into the hole provided in the first sheet.

### Advantageous Effects of Invention

According to the present invention, it is possible to provide an arc spot welding method for joining dissimilar materials by which dissimilar materials that are an Al-based material or an Mg-based material and a steel material to can be joined each other using inexpensive arc welding equipment which has already been widely used, and by which a weld joint of dissimilar materials that is excellent in both a tensile shear strength and a cross tensile strength can be obtained. Further, according to the present invention, it is possible to provide a weld joint of dissimilar materials that is excellent in both the tensile shear strength and the cross tensile strength.

### BRIEF DESCRIPTION OF DRAWINGS

FIG. 1A is a perspective view illustrating an arc spot welding method for joining dissimilar materials according to an embodiment of the present invention in order of steps, and is a view illustrating step S1.

FIG. 1B is a perspective view illustrating the arc spot welding method for joining dissimilar materials according to the embodiment of the present invention in order of steps, and is a view illustrating step S2.

FIG. 1C is a perspective view illustrating the arc spot welding method for joining dissimilar materials according to the embodiment of the present invention in order of steps, and is a view illustrating step S3.

FIG. 1D is a perspective view illustrating the arc spot welding method for joining dissimilar materials according to the embodiment of the present invention in order of steps, and is a view illustrating step S4.

FIG. 2 is a cross-sectional view illustrating a weld joint of dissimilar materials obtained by the arc spot welding method for joining dissimilar materials according to the embodiment of the present invention.

FIG. 3 is a graph showing a relation between the kind of a steel sheet and a strength of a joint in the case where a wire containing no Ni is used.

FIG. 4 is a graph showing a cross-sectional hardness of a joint in the case where a wire containing no Ni is used with a vertical axis representing the Vickers hardness and a horizontal axis representing a distance from a center line L of a weld.

FIG. 5 is a graph showing a cross-sectional hardness of a joint in the case of using a steel sheet C with a vertical axis representing Vickers hardness and a horizontal axis representing a distance from a center line L of a weld.

FIG. 6 is a schematic diagram showing a specific method of a cross tensile test.

FIG. 7 is a schematic cross-sectional view illustrating a weld joint of dissimilar materials after welding.

FIG. 8A is a schematic cross-sectional view illustrating a state after a cross tensile test is performed on a weld joint of dissimilar materials that is joined using steel sheets A and B each having a tensile strength of 1.0 GPa or less and a wire I containing no Ni.

FIG. 8B is a schematic cross-sectional view illustrating a state after a cross tensile test is performed on a weld joint of dissimilar materials that is joined using a steel sheet C having a tensile strength of 1.5 GPa and the wire I containing no Ni.

FIG. 8C is a schematic cross-sectional view illustrating a state after a cross tensile test is performed on a weld joint of dissimilar materials that is joined using the steel sheet C having a tensile strength of 1.5 GPa and a wire III having a Ni content of 96.3 mass %.

FIG. 9 is a drawing substitute photograph showing a cross section of a joint obtained by welding using a welding wire for stainless steel, and a view showing a relation between a cross-sectional position and a cross-sectional hardness of the joint.

FIG. 10 is a drawing substitute photograph showing a cross section of a joint obtained by welding using a welding wire for high tensile steel containing no Ni, and a view showing a relation between a cross-sectional position and a cross-sectional hardness of the joint.

FIG. 11 is a cross-sectional view illustrating another example of the weld joint of dissimilar materials obtained by the arc spot welding method for joining dissimilar materials according to the embodiment of the present invention.

FIG. 12 is a side view illustrating a size of a joining auxiliary member used in the present Example.

FIG. 13 is a top view illustrating a size of a test sample for a tensile shear test.

FIG. 14 is a top view illustrating a size of a test sample for a cross tensile test.

FIG. 15 is a graph showing a relation between the kinds of wires and the strength of the joint in the case where the steel sheet C is used.

FIG. 16 is a graph showing a relation between the kinds of wires having various Ni contents and the strength of the joint in the case where the steel sheet C is used.

FIG. 17 is a graph showing a relation between the kind of wires and the strength of the joint in the case where the steel sheet A is used.

FIG. 18 is a graph showing a relation between the kind of wires and the strength of the joint in the case where the steel sheet B is used.

### DESCRIPTION OF EMBODIMENTS

Hereinafter, an arc spot welding method for joining dissimilar materials and a weld joint of dissimilar materials according to an embodiment of the present invention will be described in detail with reference to the drawings.

### Arc Spot Welding Method for Joining Dissimilar Materials

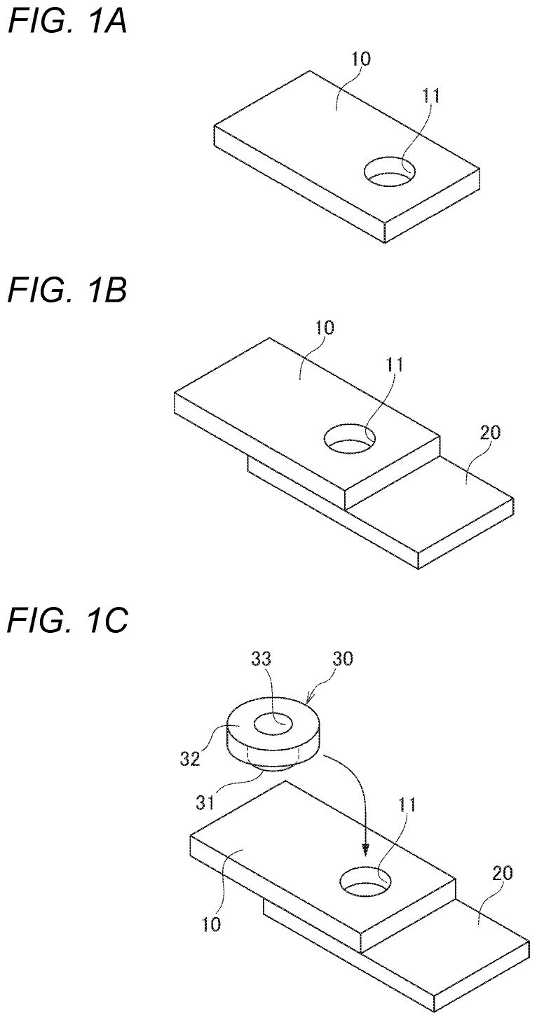

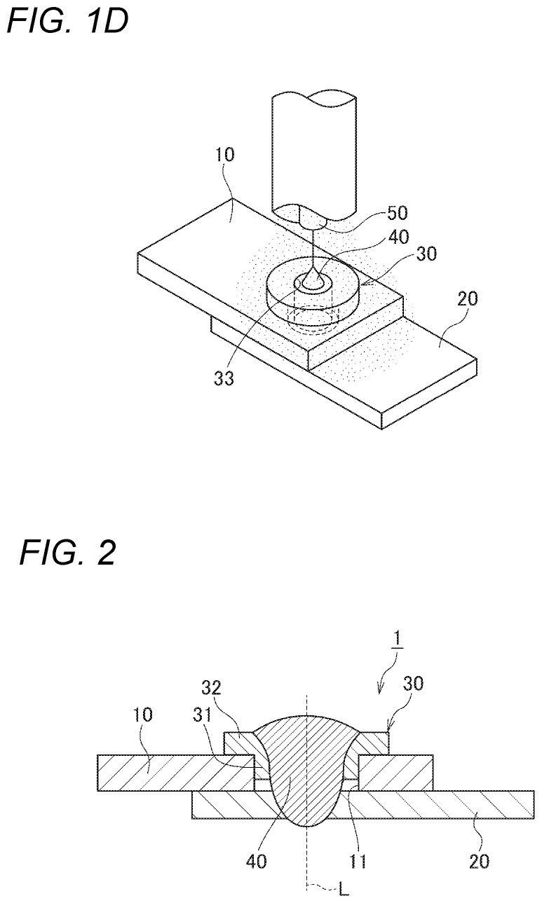

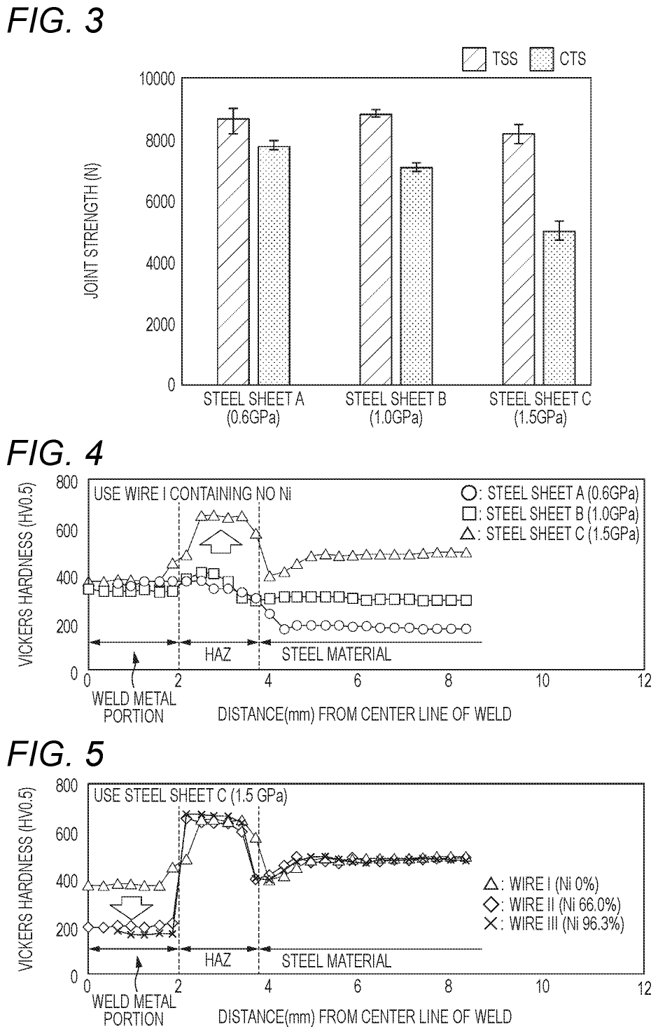

FIGS. 1A to 1D are perspective views illustrating the arc spot welding method for joining dissimilar materials according to the embodiment of the present invention in order of steps. FIG. 2 is a cross-sectional view illustrating the weld joint of dissimilar materials that is obtained by the arc spot welding method for joining dissimilar materials according to the embodiment of the present invention.

As shown in FIGS. 1A to 1D and 2, the arc spot welding method for joining dissimilar materials according to the present embodiment is a welding method in which an upper sheet (first sheet) 10 made of an Al-based material or an Mg-based material and a lower sheet (second sheet) 20 made of steel, which overlap each other, are joined by an arc spot welding method via a joining auxiliary member 30.

A specific arc spot welding method for joining dissimilar materials will be described with reference to FIGS. 1A to 1D. First, as illustrated in FIG. 1A, a drilling operation is performed on the upper sheet 10 to form a hole 11 penetrating in a sheet thickness direction and facing an overlapping surface of the lower sheet 20 (step S1). Examples of specific methods of the drilling operation include (A) cutting using a rotary tool such as an electric drill or a ball disk, (B) punching using a punch, and (C) press-mold removal using a mold.

Next, as shown in FIG. 1B, an overlapping operation is performed to overlap the upper sheet 10 and the lower sheet 20 (step S2). In the present embodiment, the lower sheet 20 is made of steel having a tensile strength of 1180 MPa or more, for example, ultra-high tensile steel having a tensile strength of 1.5 GPa.

Further, as illustrated in FIG. 1C, an insertion portion 31 of the joining auxiliary member 30 is inserted into the hole 11 of the upper sheet 10 from an upper surface of the upper sheet 10 (step S3). The joining auxiliary member 30 has, for example, a stepped outer shape having the insertion portion 31 to be inserted into the hole 11 of the upper sheet 10 and a flange-shaped non-insertion portion 32 disposed on the upper surface of the upper sheet 10. In addition, a hollow portion 33 penetrating the insertion portion 31 and the non-insertion portion 32 is formed in the joining auxiliary member 30. That is, the joining auxiliary member 30 is inserted into the hole of the upper sheet 10 such that a penetration direction of the hollow portion 33 is the sheet thickness direction of the upper sheet 10 and the lower sheet 20. An outer shape of the non-insertion portion 32 is not limited to a circular shape as illustrated in FIG. 1C, and may be any shape. A shape of the hollow portion 33 is not limited to the circular shape, and may be any shape.

Subsequently, as illustrated in FIG. 1D, a welding wire (welding material) 50 containing 13 mass % or more of Ni is used, and the lower sheet 20 and the joining auxiliary member 30 are melted and the welding wire 50 is melted by arc welding, thereby filling the hollow portion 33 of the joining auxiliary member 30 with the weld metal 40, so that the upper sheet 10 and the lower sheet 20 are joined (step S4). In this way, the weld joint 1 of dissimilar materials shown in FIG. 2 can be obtained. It should be noted that FIG. 1D shows a case where a consumable electrode type electrode gas-shielded arc welding method is used as an example of arc welding.

Here, what inventors of the present application have been studied regarding a mechanism in which the joint strength changes depending on the kinds of the steel material and the welding wire in the case where the Al-based material (the upper sheet 10) and the steel material (the lower sheet 20) are joined according to the method shown in steps S1 to S4 will be described.

First, the inventors of the present application joined the upper sheet 10 and the lower sheet 20 by using steel sheets having tensile strengths different from each other as the lower sheet 20, using an aluminum alloy sheet as the upper sheet 10, using the wire I containing no Ni, and employing the method shown in steps S1 to S4 for other welding conditions. Then, the tensile shear strength (TSS) and the cross tensile strength (CTS) of the obtained joints were measured.

FIG. 3 is a graph showing a relation between the kind of the steel sheets and the strength of the joint in the case where a wire containing no Ni is used.

As shown in FIG. 3, even when a steel sheet A having a tensile strength of 0.6 GPa and a steel sheet B having a tensile strength of 1.0 GPa are separately joined to an aluminum alloy sheet using the wire I not using Ni, there is no large difference in the values of TSS and CTS.

On the other hand, as shown in FIG. 3, it can be seen that in the case of using a steel sheet C having a tensile strength of 1.5 GPa, the CTS is greatly decreased.

Therefore, the inventors of the present application considered that the hardness at each position of the joint affects the tensile strength of the joint, and joined the upper sheet 10 and the lower sheet 20 and measured the cross-sectional hardness of the obtained joint in the same manner as the conditions for measuring the strength of the joint.

FIG. 4 is a graph showing a cross-sectional hardness of the joint in the case where a wire containing no Ni is used with a vertical axis representing the Vickers hardness and a horizontal axis representing a distance from a center line L of a weld. In FIG. 4, the graph indicated by ○ represents a hardness of a weld joint using the steel sheet A having a tensile strength of 0.6 GPa as the lower sheet 20, the graph indicated by □ represents a hardness of a weld joint using the steel sheet B having a tensile strength of 1.0 GPa as the lower sheet 20, and the graph indicated by Δ represents a hardness of a weld joint using the steel sheet C having a tensile strength of 1.5 GPa as the lower sheet 20.

In addition, an area at a distance of 0 mm to about 2 mm from the center line L of the weld represents a weld metal portion (a part where the weld metal is formed), an area at a distance of about 2 mm to about 4 mm represents a heat-affected zone (HAZ), and an area at a distance of about 4 mm or more represents a steel sheet (the lower sheet 20).

As shown in FIG. 4, the Vickers hardness of the HAZ in the weld joint using the steel sheet C having a tensile strength of 1.5 GPa was about 650 HV0.5, which was 1.5 times or more higher than the Vickers hardness of about 370 HV0.5 of the HAZ in the weld joint using the other steel sheets A and B.

It is considered that this is because the carbon amount of the steel sheet C is larger than the carbon amounts of the other steel sheets A and B.

Next, the inventors of the present application joined the upper sheet 10 and the lower sheet 20 by using the steel sheet C having a tensile strength of 1.5 GPa as the lower sheet 20, using an aluminum alloy sheet as the upper sheet 10, using wires having different Ni contents from each other, and employing the method shown in steps S1 to S4 for other welding conditions, and measured the cross-sectional hardness of the obtained joint.

FIG. 5 is a graph showing a cross-sectional hardness of a joint in the case of using the steel sheet C with a vertical axis representing the Vickers hardness and a horizontal axis representing a distance from the center line L of a weld. In FIG. 5, the graph indicated by Δ represents a hardness of a weld joint using the wire I containing no Ni, the graph indicated by ⋄ represents a hardness of a weld joint using a wire II having a Ni content of 66.0 mass % with respect to the total mass of the wire, and the graph indicated by x represents a hardness of a weld joint using a wire III having a Ni content of 96.3 mass % with respect to the total mass of the wire.

In addition, similarly to FIG. 4, an area at a distance of 0 mm to about 2 mm from the center line L of the weld represents the weld metal portion, an area at a distance of about 2 mm to about 4 mm represents the heat-affected zone (HAZ), and an area at a distance of about 4 mm or more represents the steel sheet (lower sheet 20).

As shown in FIG. 5, when the wires II and III containing Ni were used in the case where the steel sheet C having a tensile strength of 1.5 GPa was used, the Vickers hardness of the weld metal was about 170 HV0.5, which showed a tendency of softening compared with the Vickers hardness of about 370 HV0.5 of the weld metal in the case where the wire I containing no Ni was used.

In the case where the steel sheet C having a tensile strength of 1.5 GPa was used and the wires II and III containing Ni were used, CTS equivalent to that obtained in the case where the steel sheets A and B each having a tensile strength of 1.0 GPa or less were used and the wire I containing no Ni was used was obtained.

From the above results, the inventors of the present application presumed the fracture mechanism in the cross tensile test (CTS).

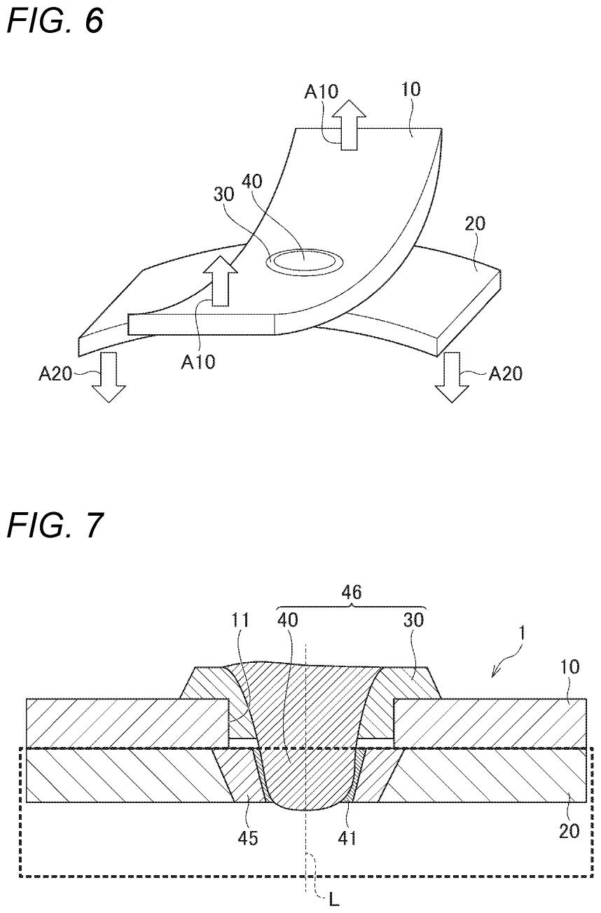

FIG. 6 is a schematic diagram showing a specific method of the cross tensile test. As shown in FIG. 6, the upper sheet 10 and the lower sheet 20 in which one piece is formed in a size longer than the other piece in a plan view are prepared, and the upper sheet 10 and the lower sheet 20 overlap each other such that the upper sheet 10 and the lower sheet 20 form a cross in a plan view. In the examination test, welding using the joining auxiliary member was performed by the method shown in FIGS. 1(C) and 1(D) using the lower sheet 20 having different tensile strengths and the wires having different Ni contents. Thereafter, both ends of the upper sheet 10 in a longitudinal direction were pulled in a direction indicated by arrows A10, and both ends of the lower sheet 20 in the longitudinal direction were pulled in a direction indicated by arrows A20, and the maximum tensile load until a test piece was broken was measured.

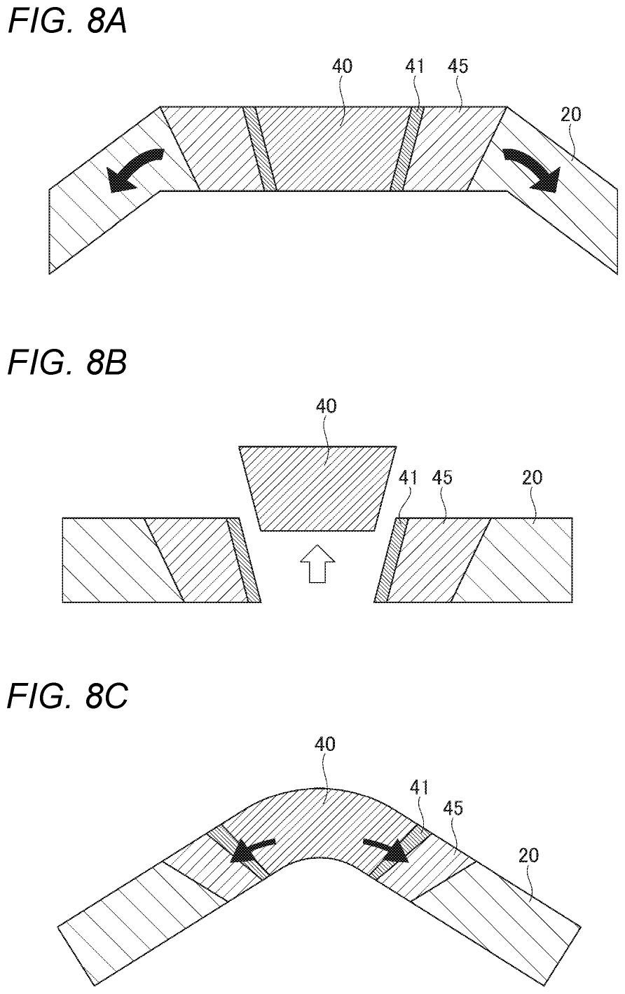

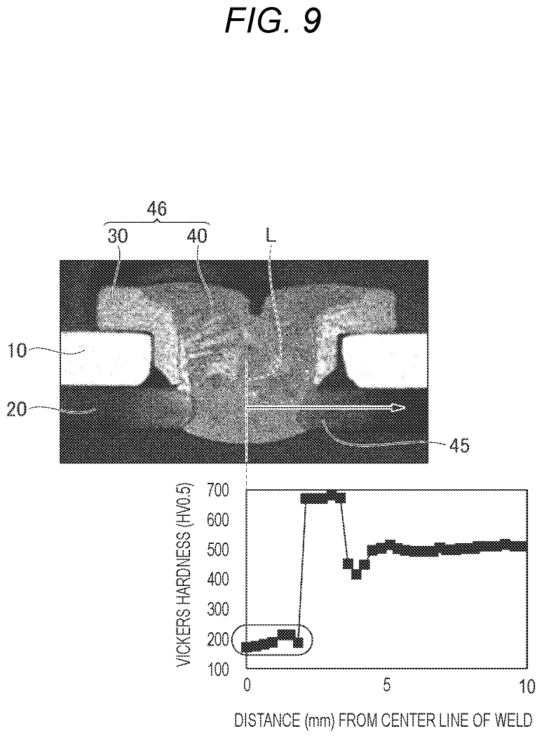

FIG. 7 is a schematic cross-sectional view illustrating a weld joint of dissimilar materials after welding. FIG. 8A is a schematic cross-sectional view illustrating a state after a cross tensile test is performed on a weld joint of dissimilar materials that is joined using the steel sheets A and B each having a tensile strength of 1.0 GPa or less and the wire I containing no Ni. FIG. 8B is a schematic cross-sectional view illustrating a state after a cross tensile test is performed on a weld joint of dissimilar materials that is joined using the steel sheet C having a tensile strength of 1.5 GPa and the wire I containing no Ni. FIG. 8C is a schematic cross-sectional view illustrating a state after a cross tensile test is performed on a weld joint of dissimilar materials that is joined using the steel sheet C having a tensile strength of 1.5 GPa and the wire III having a Ni content of 96.3 mass %.

FIGS. 8A to 8C illustrate only a part surrounded by a broken line in the cross-sectional view of the weld joint 1 of dissimilar materials illustrated in FIG. 7.

As illustrated in FIG. 7, the upper sheet 10 and the lower sheet 20 are joined by a joint portion 46, and the joint portion 46 includes the joining auxiliary member 30 and the weld metal 40. It should be noted that, regardless of the kinds of the wires and the steel materials, in the obtained weld joint 1 of dissimilar materials, an HAZ 45 is formed in an area adjacent to the weld metal 40 in the lower sheet (steel sheet) 20. The weld metal 40 has an interface portion (bond) 41 between the weld metal 40 and the HAZ 45.

As illustrated in FIG. 8A, in the weld joint using the steel sheets A and B each having a tensile strength of 1.0 GPa or less and using the wire I containing no Ni, the HAZ 45 is not significantly hardened, and the lower sheet 20 itself deforms in the direction indicated by the arrows in the cross tensile test. Accordingly, a higher CTS is shown.

On the other hand, in the weld joint using the steel sheet C having a tensile strength of 1.5 GPa and using the wire I containing no Ni, the amount of carbon contained in the lower sheet (steel sheet) 20 is large, so that the HAZ is remarkably hardened. Therefore, as illustrated in FIG. 8B, stress concentrates on the interface portion (bond) 41 between the weld metal 40 and the hardened HAZ 45. As a result, it is considered that in the cross tensile test, brittle fracture occurred in the interface portion 41, and the CTS decreased.

In the weld joint using the steel sheet C having a tensile strength of 1.5 GPa and the wire III having a Ni content of 96.3 mass %, the HAZ is remarkably hardened as in the case illustrated in FIG. 8B. However, the wire III having a Ni content of 96.3 mass % is used, so that Ni is contained in the weld metal 40, and a structure of the weld metal 40 becomes an austenite crystal structure having a large elongation and is softened. Therefore, it is considered that when the upper sheet 10 and the lower sheet 20 are joined by the arc spot welding method for joining dissimilar materials according to the present embodiment, the weld metal 40 deforms in the direction indicated by the arrows in the cross tensile test as illustrated in FIG. 8C, so that brittle fracture is prevented and CTS is improved.

Furthermore, the inventors of the present application conducted further studies on a welding material which can make the structure of the weld metal 40 an austenite crystal structure that is soft and has high ductility, and which is lower in cost. Specifically, arc spot welding was performed using a relatively inexpensive welding wire for stainless steel (JIS Z 3321 YS310) as a welding material that allows the weld metal to have an austenite crystal structure, and the cross-sectional hardness of the joint was measured. In addition, for comparison, arc spot welding was performed using a welding wire for high tensile steel (JIS Z 3317 G52A-1CM3), which contains no Ni, and the cross-sectional hardness of the joint was measured in the same manner. It should be noted that the Ni content of the used welding wire for stainless steel is 20.0 mass % to 22.5 mass %.

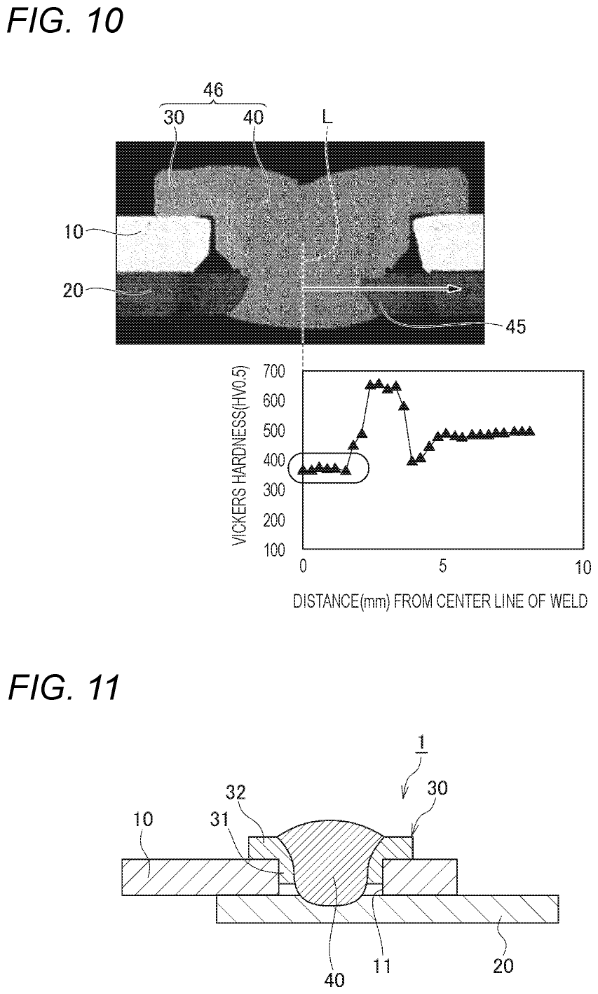

FIG. 9 is a drawing substitute photograph showing a cross section of a joint obtained by welding using a welding wire for stainless steel, and a view showing a relation between a cross-sectional position and a cross-sectional hardness of the joint. It should be noted that the Ni content of the welding wire for stainless steel (JIS Z 3321 YS 310), which is used for welding the joint shown in FIG. 9, is 21.21 mass %. FIG. 10 is a drawing substitute photograph showing a cross section of a joint obtained by welding using a welding wire for high tensile steel containing no Ni, and a view showing a relation between a cross-sectional position and a cross-sectional hardness of the joint. In FIGS. 9 and 10, the horizontal axes of the graphs represent the distance (mm) from the center line L of the weld, and corresponds to the position in the drawing substitute photograph showing the cross section of the joint.

In FIGS. 9 and 10, a part surrounded by a circle in the graph represents an area of a weld metal. As shown in FIGS. 9 and 10, the maximum hardness (about 210 Hv) of the weld metal obtained using the welding wire for stainless steel was remarkably lower than the maximum hardness (about 380 Hv) of the weld metal obtained using the welding wire for high tensile steel. Based on this result, it is considered that even when the welding wire for stainless steel is used, the weld metal has a soft and high-ductility austenite crystal structure. Therefore, the bending deformability of the weld metal can be increased, and the cross tensile strength can be improved.

Next, the upper sheet 10, the lower sheet 20, the welding material and the joining auxiliary member 30 used in the welding method according to the present embodiment, and a specific welding method will be described in detail below.

### Lower Plate (Steel Plate)

As described above, the lower sheet 20 to be welded in the present embodiment is a steel material having a tensile strength of 1180 MPa or more. In such a steel material, the C content relative to the total mass of the steel material is preferably 0.2 mass % or more and 0.5 mass % or less.

As shown in FIG. 8A, since a steel material having a tensile strength of less than 1180 MPa can obtain a high strength regardless of the kind of the wire, it is not necessary to limit the welding material. Therefore, the above steel material is not used as a welding target in the present embodiment.

### Upper Plate (Plate of Al-Based Material or Mg-Based Material)

In the present embodiment, as a target of joining of dissimilar materials with the lower sheet 20, a sheet made of an Al-based material or an Mg-based material as a material different from that of the lower sheet 20 is used as the upper sheet 10. In the present embodiment, the composition of the upper sheet 10 is not particularly limited. As described above, the Al-based material means pure aluminum or an aluminum alloy, and the Mg-based material means pure magnesium or a magnesium alloy.

### Welding Material

As the welding material that can be used in the present embodiment, a welding wire that is generally used can be applied as long as it is made of a material containing 13 mass % or more of Ni. Specifically, the Ni content with respect to the total mass of the welding material is 13 mass % or more, and the Ni content is preferably 21 mass % or more. The Ni content is more preferably 96 mass % or more in consideration of only the strength of the joint. The upper limit of the Ni content is not particularly limited, and is preferably 98 mass % or less. The Ni content is more preferably 22.5 mass % or less in consideration of the cost of the welding material and the like.

Specifically, stainless steel welding filler materials YS 310 and YS 309 described in JIS Z 3321, nickel and nickel alloy covered electrodes described in JIS Z 3224: 2010, flux-cored wires for nickel and nickel alloy arc welding described in JIS Z 3335: 2014, solid wires and welding filler rods for nickel and nickel alloy welding described in JIS Z 3334: 2011, and the like can be used.

It should be noted that examples of the components other than Ni in the welding material include C, Si, Mn, Cr, Ti, Al, Fe, Mo, and Ca. In the composition of the welding material, for example, the total content of Cr, Ni, and Fe is preferably 85 mass % or more, more preferably 90 mass % or more, and still more preferably 95 mass % or more.

As described above, the arc spot welding method for joining dissimilar materials according to the present embodiment is used for joining a high tensile steel of 1180 MPa or more and a sheet made of an Al-based material or an Mg-based material, and a wire containing 13 mass % or more of Ni is used. Therefore, a weld joint excellent in both the TSS and the CTS can be obtained.

### Joining Auxiliary Member

The joining auxiliary member 30 made of steel, which is used in the arc spot welding method, functions as a protective wall for avoiding melting of, for example, an Al-based material or an Mg-based material. In the upper sheet 10 made of the Al-based material or the Mg-based material, the portions that are most likely to be melted during welding are an inner surface of the hole 11 and a surface around the inner surface. By covering these surfaces with the joining auxiliary member 30, heat of arc welding can be prevented from being directly transferred to the upper sheet 10, and an intermetallic compound (IMC) can be prevented from being generated by mixing with a component of the welding material. That is, when a fusion penetration range of the arc welding is only the joining auxiliary member 30 and the lower sheet 20, the dilution of the component of the upper sheet 10 (the Al-based material or the Mg-based material) to the weld metal 40 is zero, and the generation of the IMC is completely prevented. Therefore, a high joint strength can be obtained.

However, in the present embodiment, the occurrence of IMC does not need to be zero, and formation of some IMC is allowed. This is because, even when the IMC is formed on the inner surface of the hole 11, the influence of an IMC layer formed around the weld metal 40 is small because the weld metal 40 acts as a resistance to external stress in a sheet width direction (two-dimensional direction) as long as the weld metal 40 has ductility and appropriate strength. In addition, the IMC is brittle, but the compression stress and the tensile stress are simultaneously applied to the joint portion, and the IMC maintains sufficient strength against the compression force even when tensile stress is applied to the structure. Therefore, the formation of the IMC layer does not cause fracture propagation. Therefore, the insertion portion 31 of the joining auxiliary member 30 is not necessarily the same as the upper sheet 10 in terms of the sheet thickness.

In the present embodiment, as shown in FIG. 2, the joining auxiliary member 30 preferably has a stepped outer shape having the insertion portion 31 and the non-insertion portion 32. When the joining auxiliary member 30 has the shape described above, the strength can be maintained even in the case where an external force in the sheet thickness direction is applied as in the cross tensile test.

As the steel material constituting the joining auxiliary member 30, for example, mild steel, carbon steel, or stainless steel can be used.

### Specific Welding Method

As described above, the step of joining the upper sheet 10 and the lower sheet 20 by the arc welding in step S4 is required to melt the lower sheet 20 and the joining auxiliary member 30 and fill the hollow portion 33 provided in the joining auxiliary member 30 with the weld metal 40. In order to obtain a good CTS, it is necessary to form a weld metal containing Ni. Therefore, in the arc welding, it is essential to insert, as a welding material serving as a filler, the welding wire (welding material) 50 made of a material containing 13 mass % or more of Ni.

Therefore, in the present embodiment, for example, the following welding methods (a) to (e) can be used.

### “(a) Gas-Shielded Arc Welding Method in Which Welding Material Containing 13 Mass % or More of Ni is Used as Wire of Consumable Electrode Type”

The consumable electrode type gas-shielded arc welding method is a welding method generally referred to as MAG or MIG, and is a welding method of forming a sound weld by using a solid wire or a flux-cored wire as a filler and arc generating consumable electrode and shielding a weld from the atmosphere by a shielding gas such as CO₂, Ar or He.

### “(b) Non-Gas Arc Welding Method in Which Welding Material Containing 13 Mass % or More of Ni is Used as Wire of Consumable Electrode Type”

The non-gas arc welding method is also referred to as a self-shielded arc welding method, and is a welding method of forming a sound weld without a shielding gas by using a special flux-cored wire as a filler and arc generating consumable electrode.

### “(c) Gas Tungsten Arc Welding Method in Which Welding Material Containing 13 Mass % or More of Ni is Used as Filler of Non-Consumable Electrode Type”

The gas tungsten arc welding method is a kind of gas-shielded arc welding method, but is a non-consumable electrode type and is also generally referred to as TIG. An inert gas that is Ar or He is used as the shielding gas. An arc is generated between a tungsten electrode and a base metal, and the filler wire is fed to the arc from a lateral side.

In general, the filler wire is not energized, but there is also a hot-wire type TIG in which a filler wire is energized to increase a melting rate. In this case, no arc is generated in the filler wire.

### “(d) Plasma Arc Welding Method in Which Welding Material Containing 13 Mass % or More of Ni is Used as Filler of Non-Consumable Electrode Type”

The plasma arc welding method has the same principle as TIG, but is a welding method in which the arc force is increased by contracting the arc by making a double system of a gas and increasing the speed.

### “(e) Coated Arc Welding Method in Which Welding Material Containing 13 Mass % or More of Ni is Used as Welding Electrode of Consumable Electrode Type”

The coated arc welding method is an arc welding method in which a covered electrode in which flux is applied to a metal core wire is used as a filler, and a shielding gas is unnecessary.

In the present embodiment, as described above, the hollow portion 33 of the joining auxiliary member 30 is filled with the weld metal using the welding material containing 13 mass % or more of Ni, and in general, a target position of the wire or the welding electrode does not need to be moved, and the arc may be cut after an appropriate feeding time to end the welding. However, in the case where the area of the hollow portion 33 is large, the target position of the wire or the welding electrode may be moved in a manner of drawing a circle in the hollow portion 33.

It is desirable that the hollow portion 33 of the joining auxiliary member 30 is filled with the weld metal 40, and further, an excess weld metal (in FIG. 2, a part of the weld metal 40, which protrudes above the joining auxiliary member 30) is formed on a surface of the joining auxiliary member 30. By forming the excess weld metal, in particular, high strength can be obtained against the external stress in the sheet thickness direction (three-dimensional direction).

In addition, as shown in FIG. 2, it is preferable that, regarding fusion penetration on a side opposite to the excess weld metal side, the weld metal 40 is melted to a state where the thickness of the weld metal 40 exceeds the sheet thickness of the lower sheet 20 and a back bead appears. When the weld metal 40 is melted into the lower sheet 20 until a state where a back bead appears, the upper sheet 10 and the lower sheet 20 can be joined with a high strength.

Furthermore, a strength of a joint interface can be estimated by checking the occurrence of the back bead during welding, so that it is preferable to melt the weld metal until the back bead appears.

However, in the present embodiment, as shown in FIG. 2, it is not necessary to melt the weld metal to the state where the back bead appears, and as shown in FIG. 11, the lower sheet 20 may be appropriately melted.

The sheet thicknesses of the upper sheet 10 and the lower sheet 20 are not necessarily limited, and the sheet thickness of the upper sheet 10 is preferably 4.0 mm or less in consideration of working efficiency and a shape of the lap welding. On the other hand, in consideration of heat input in arc welding, when the sheet thickness is excessively small, burn-through occurs during the welding and the welding is difficult. Therefore, the sheet thicknesses of the upper sheet 10 and the lower sheet 20 are both preferably set to 0.5 mm or more.

### Weld Joint of Dissimilar Materials

The weld joint of dissimilar materials according to the present embodiment is produced by the arc spot welding method for joining dissimilar materials. That is, the weld joint of dissimilar materials according to the present embodiment includes the first sheet made of the Al-based material or the Mg-based material, the second sheet made of ultra-high tensile steel having a tensile strength of 1180 MPa or more, and a joint portion where the first sheet and the second sheet are joined. Here, the “joint portion” refers to a part related to the joining between the first sheet and the second sheet, and may be referred to as a “weld”.

As shown in FIG. 2, the upper sheet (first sheet) 10 has the hole 11 facing an overlapping surface with the lower sheet (second sheet) 20. The joint portion includes the joining auxiliary member 30 and the weld metal 40. The joining auxiliary member 30 has a hollow portion penetrating in a direction orthogonal to the overlapping surface, and is inserted into the hole 11 provided in the upper sheet 10. Further, the weld metal 40 includes a part of the joining auxiliary member 30 and a part of the lower sheet 20, and the hollow portion of the joining auxiliary member 30 is filled with the weld metal 40.

Further, the weld metal 40 contains Ni, and contains a steel component constituting the joining auxiliary member 30 and an ultra-high tensile steel component constituting the lower sheet 20.

In the present embodiment, as shown in FIG. 7, the heat-affected zone 45 is formed at a position adjacent to the joint portion 46 in the lower sheet 20. The lower sheet 20 targeted by the present invention is made of the ultra-high tensile steel having a tensile strength of 1180 MPa or more, so that the hardness of the heat-affected zone 45 is higher than the hardness of the area of the lower sheet 20 excluding the heat-affected zone 45. That is, when the maximum hardness of the heat-affected zone 45 is 130% or more with respect to the average hardness of the area of the lower sheet 20 excluding the heat-affected zone 45 (the base metal part of the lower sheet 20), it can be determined that the lower sheet 20 is ultra-high tensile steel having a tensile strength of 1180 MPa or more. That is, in the present embodiment, a large effect can be obtained in the case where the maximum hardness of the heat-affected zone 45 is 130% or more with respect to the average hardness of the base metal part of the lower sheet 20.

In the present embodiment, welding is performed using the welding material containing 13 mass % or more of Ni, so that the weld metal 40 is softened, and the maximum hardness thereof is lower than the average hardness of the area of the lower sheet 20 excluding the heat-affected zone 45. When the maximum hardness of the weld metal 40 is 50% or less with respect to the average hardness, the weld metal 40 is sufficiently softened and becomes a uniform soft structure without unevenness in hardness, so that the CTS can be further improved. Accordingly, the maximum hardness of the weld metal 40 is preferably 50% or less with respect to the average hardness.

The maximum hardness of the weld metal 40 is a value obtained by measuring the Vickers hardness at a pitch of 0.3 mm in accordance with JIS Z 2244:2009 along a direction orthogonal to the sheet thickness with reference to a position lower by 0.7 mm in the sheet thickness direction from an upper surface (surface in contact with the upper sheet 10) of the lower sheet 20 in the cross section of the obtained joint, and reading the maximum hardness of the weld metal 40. The maximum hardness of the heat-affected zone 45 is a value obtained by measuring the Vickers hardness at a pitch of 0.3 mm by the same method as the method of measuring the maximum hardness of the weld metal 40 and reading the maximum hardness of the heat-affected zone 45. The average hardness of the area of the lower sheet 20 excluding the heat-affected zone 45 is a value obtained by measuring the Vickers hardness at a pitch of 0.3 mm by the same method as the method of measuring the maximum hardness of the weld metal 40 from a position 6 mm along the direction orthogonal to the sheet thickness from the center line L of the weld metal 40 to a position of 8.1 mm therefrom, and averaging the measured values at eight points in total. The maximum hardness of the weld metal, the maximum hardness of the heat-affected zone, and the average hardness of the area of the lower sheet excluding the heat-affected zone may be measured at any position as long as the maximum hardness or the average hardness of the required portion can be correctly measured. For example, the measurement may be performed along a direction orthogonal to the sheet thickness with reference to a center of the sheet thickness of the lower sheet 20.

The maximum hardness of the heat-affected zone to the average hardness of the area excluding the heat-affected zone (average hardness of the lower sheet) in the lower sheet (%) can be calculated by the following expression.

((Maximum hardness of heat-affected zone/(average hardness of lower sheet))×100

Further, the maximum hardness of the weld metal to the average hardness of the area excluding the heat-affected zone in the lower sheet (average hardness of the lower sheet) (%) can be calculated by the following expression.

((Maximum hardness of weld metal)/(average hardness of lower sheet))×100

In the weld joint of dissimilar materials configured as described above, the weld metal 40 contains Ni that is the main component of the welding material used in the welding method according to the present embodiment. Therefore, the weld metal 40 is softened, brittle fracture is prevented, and the excellent TSS and CTS can be obtained.

The present invention is not limited to the embodiment described above, and modifications, improvements, and the like can be made as appropriate.

### EXAMPLES

### 1. Example 1

Hereinafter, Examples of the arc spot welding method for joining dissimilar materials according to the present embodiment will be specifically described in comparison with Comparative Examples. In Example 1, arc spot welding was performed using a wire I containing no Ni, a wire II having a Ni content of 66.0 mass %, and a wire III having a Ni content of 96.3 mass %, and the strength was measured by a tensile shear test and a cross tensile test.

First, in step S1, the joining auxiliary member 30 made of steel was produced, an aluminum alloy sheet (A6022-T4) having a thickness of 2.0 mm was prepared as the upper sheet (first sheet) 10, and a 1.5 GPa class ultra-high tensile steel sheet (steel sheet C) having a thickness of 1.4 mm and a carbon (C) content of 0.40 mass % was prepared as the lower sheet (second sheet) 20, thereby producing a test sample for the tensile shear test and a test sample for the cross tensile test.

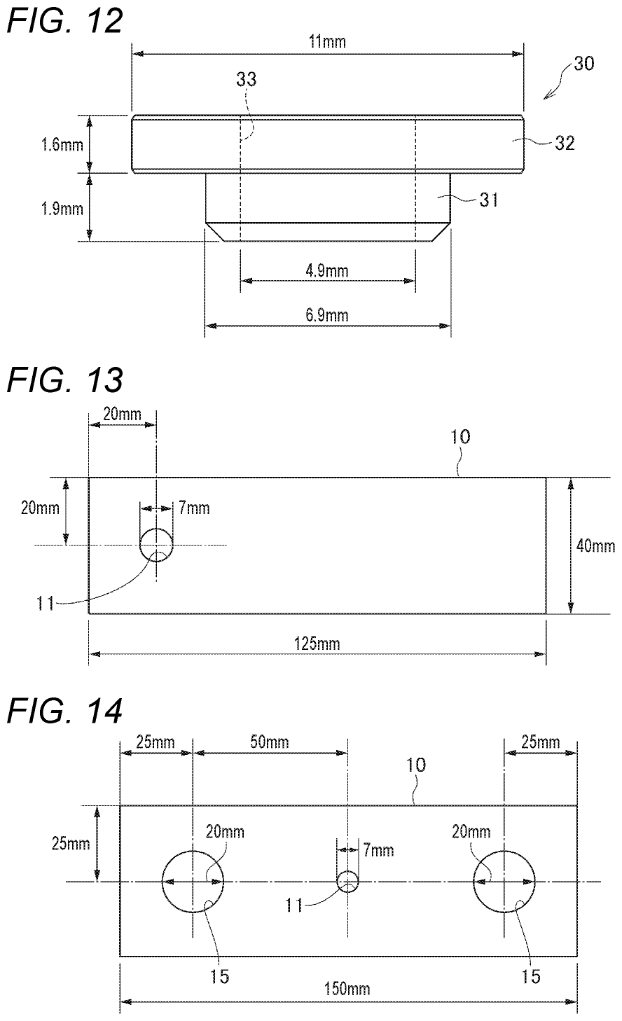

FIG. 12 is a side view illustrating a size of the joining auxiliary member used in the present Example. FIG. 13 is a top view illustrating a size of the test sample for the tensile shear test. FIG. 14 is a top view illustrating a size of the test sample for the cross tensile test.

As illustrated in FIG. 12, the joining auxiliary member 30 was made of a mild steel material, and the diameter of the insertion portion 31 was 6.9 mm, the height thereof was 1.9 mm, the diameter of the non-insertion portion 32 was 11 mm, the height thereof was 1.6 mm, and the diameter of the hollow portion 33 was 4.9 mm.

As illustrated in FIG. 13, the test sample for the tensile shear test had a length of 125 mm in the longitudinal direction and a width of 40 mm, and the hole 11 was formed such that a center of the hole was located at a position of 20 mm from one end surface in the longitudinal direction and an end surface in the width direction.

Further, as illustrated in FIG. 14, the test sample for the cross tensile test had a length in the longitudinal direction of 150 mm and a width of 50 mm. The hole 11 was formed such that the center of the hole was located at a position of 75 mm from the end surface in the longitudinal direction and 25 mm from the end surface in the width direction, and bolt holes 15 were formed at two positions such that each of centers of the holes was located at a position of 25 mm from the respective one of both end surfaces in the longitudinal direction and from the respective one of the end surfaces in the width direction. The lower sheet 20 as a test sheet for each test had the same size as the upper sheet 10, and was not provided with the hole 11.

Next, in step S2, as illustrated in FIG. 1B, the upper sheet 10 and the lower sheet 20 were overlapped. In step S3, as illustrated in FIG. 1C, the joining auxiliary member 30 was inserted into the hole 11 from the upper surface of the upper sheet 10.

Thereafter, in step S4, as illustrated in FIGS. 1D and 2, arc welding was performed at a fixed point for a certain time by metal active gas welding (MAG welding). Accordingly, the lower sheet 20 and the joining auxiliary member 30 were melted, and the welding wire 50 was melted to fill the hollow portion 33 of the joining auxiliary member 30 with the weld metal 40, thereby obtaining the weld joint 1 of dissimilar materials in which the upper sheet 10 and the lower sheet 20 are joined. Detailed welding conditions are shown in Table 1 below, and chemical compositions of the welding wires 50 used are shown in Table 2 below.

Thereafter, a tensile test was performed on the weld joint 1 of dissimilar materials in accordance with JIS Z3136 “test piece size and test method for shear test of resistance spot and projection weld joint” and JIS Z3137 “cross tensile test of resistance spot and projection weld joint”. The measurement results of the tensile test are shown in Table 3 below and FIG. 15. In Table 3 below and FIG. 15, TSS represents a tensile strength measured by the tensile shear test, and CTS represents a tensile strength measured by the cross tensile test.

TABLE 1

| Items | Welding conditions |
|---|---|
| Current polarity | DCEP (direct current electrode positive) |
| Welding wire | Diameter: 1.2 mm (composition is described in |
| | Table 2) |
| Material of upper sheet | Aluminum alloy material (6000 series) |
| Material of lower sheet | Ultra-high tensile steel sheet material (1.5 |
| | GPa class) |
| Shielding gas | 100% CO₂ |
| Welding current value | 160 to 190 A |
| Weld voltage value | 19 V |
| Arc time | 0.7 to 0.8 seconds |
| Power supply mode | Wire feeding control mode |

TABLE 2

| | | Content of each component (mass %) | | | | | |
|---|---|---|---|---|---|---|---|
| Kind of wires | | C | Si | Mn | Cr | Ni | Fe |
| Wire I | JIS Z3317 | 0.05 | 0.55 | 1.09 | 1.38 | — | Remainder |
| | G52A-1CM3 | | | | | | |
| Wire II | JIS Z3334 | 0.02 | 0.06 | 0.02 | 21.7 | 66.0 | — |
| | SNi6625 | | | | | | |
| Wire III | JIS Z3334 | 0.033 | 0.01 | 0.15 | — | 96.3 | 0.06 |
| | SNi2061 | | | | | | |

TABLE 3

| | | | Ni content | TSS | CTS |
|---|---|---|---|---|---|
| No. | | Kind of wires | (mass %) | (kN) | (kN) |
| Inventive Example | 1 | Wire II | 66.0 | 8.1 | 6.5 |
| | 2 | Wire III | 96.3 | 9.2 | 7.8 |
| Comparative Example | 1 | Wire I | — | 8.2 | 5.0 |

As shown in Table 3 and FIG. 12, in Inventive Examples No. 1 and No. 2, a wire containing 13 mass % or more of Ni (in particular, a wire having a Ni content of more than 50 mass %) is used, and joining is performed by the arc spot welding method for joining dissimilar materials according to the present invention. Therefore, inexpensive arc welding equipment which has already been widely used can be used, and a weld joint of dissimilar materials excellent in both the TSS and the CTS can be obtained.

On the other hand, in Comparative Example No. 1 in which the joining was performed using the wire I containing no Ni by the same welding method as that of Inventive Examples, the TSS was the same value as that of Inventive Examples, but the CTS remarkably decreased.

### 2. Example 2

Next, in Example 2, arc spot welding was performed using various wires (W1 to W6) having different Ni contents from one another, the strength was measured by a tensile shear test and a cross tensile test, and the hardness of the weld metal, the hardness of the heat-affected zone, and the hardness of the lower sheet were compared. Specific welding methods and test methods are shown below.

The method for producing a test sample for the tensile shear test and a test sample for the cross tensile test, and the size of the test samples were the same as those of Example 1, and three test samples were produced for each test. Detailed welding conditions are shown in Table 4 below, and chemical compositions of the welding wires used are shown in Table 5 below. Here, in Table 5 below, “-” indicates that the content was equal to or less than the detection limit value, and “0.00” indicates that the content was less than 0.005 mass %.

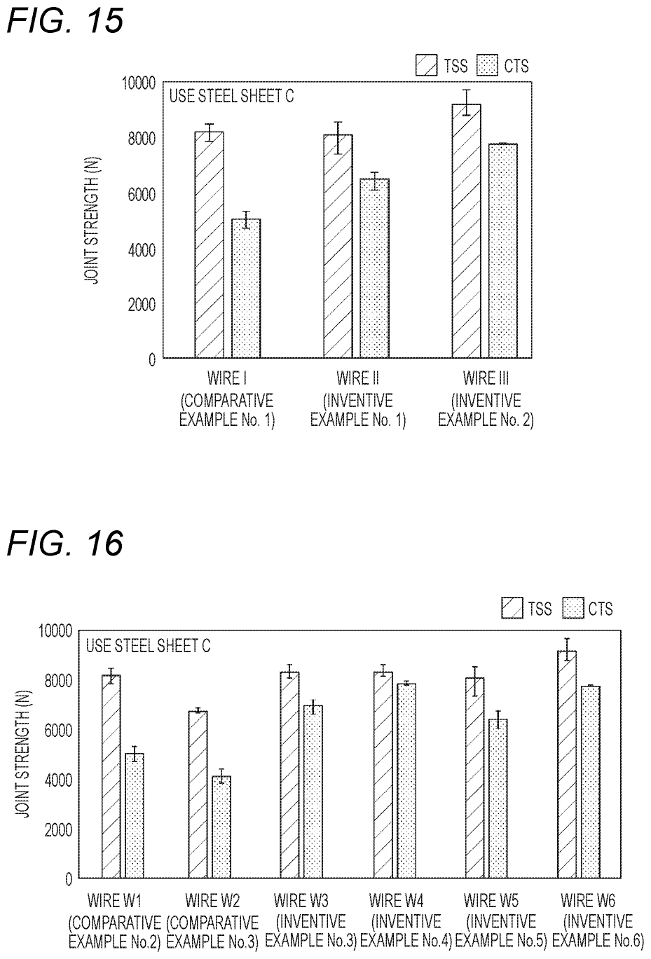

Thereafter, a tensile test was performed on each test sample of the obtained weld joint of dissimilar materials in accordance with JIS Z3136 “test piece size and test method for shear test of resistance spot and projection weld joint” and JIS Z3137 “cross tensile test of resistance spot and projection weld joint” in the same manner as in Example 1. The measurement results of the tensile test are shown in Table 6 and FIG. 16. In Table 6 below and FIG. 16, TSS represents the tensile strength measured by the tensile shear test, and CTS represents the tensile strength measured by the cross tensile test. The values of TSS and CTS shown in Table 6 below and FIG. 16 are an average value for three test samples.

The maximum hardness of the weld metal and the maximum hardness of the heat-affected zone were measured, and the hardness ratio to the average hardness of the lower sheet was calculated.

First, in the cross section of the obtained joint (test sample), the Vickers hardness was measured at a pitch of 0.3 mm in accordance with JIS Z 2244: 2009 along a direction orthogonal to the sheet thickness with reference to a position lower by 0.7 mm in the sheet thickness direction from the upper surface (surface in contact with the upper sheet) of the lower sheet. Then, the maximum hardness of the weld metal was read and defined as the maximum hardness of the weld metal. In addition, the Vickers hardness was measured at a pitch of 0.3 mm by the same method as the method of measuring the maximum hardness of the weld metal, and the maximum hardness of the heat-affected zone was read and defined as the maximum hardness of the heat-affected zone. The Vickers hardness was measured at a pitch of 0.3 mm from a position of 6 mm along the direction orthogonal to the sheet thickness from the center line of the weld metal to a position of 8.1 mm therefrom, and the measured values at eight points in total were averaged to obtain the average hardness of the lower sheet (the average hardness of the area excluding the heat-affected zone of the lower sheet).

The maximum hardness of the weld metal to the average hardness of the lower sheet (%) in Table 6 was calculated by the following expression.

((Maximum hardness of weld metal)/(average hardness of lower sheet))×100

The maximum hardness of the heat-affected zone to the average hardness of the lower sheet (%) in Table 6 was calculated by the following expression.

((Maximum hardness of heat-affected zone)/(average hardness of lower sheet))×100

TABLE 4

| Items | Welding conditions |
|---|---|
| Current polarity | DCEP (direct current electrode positive) |
| Welding wire | Diameter: 1.2 mm (composition is described |
| | in Table 5) |
| Material of upper sheet | 6000-series aluminum alloy material |
| Material of lower sheet | 1500 MPa class medium-high-carbon high |
| | tensile steel sheet |
| Shielding gas | 100% CO₂ |
| Average welding current | 128 to 131 A |
| value (effective value) | |
| Average welding voltage | 19.6 to 20.3 V |
| value (effective value) | |
| Arc time | 0.7 seconds |
| Power supply mode | Wire feeding control mode |
| | (WB-P500L manufactured by DAIHEN |
| | Corporation; Synch feed mode) |

TABLE 5

| | | Content of each component (mass %) | | | | | | | | | | | | |
|---|---|---|---|---|---|---|---|---|---|---|---|---|---|---|
| Kind of wires | | C | Si | Mn | P | S | Cr | Ti | Ni | Al | Fe | Mo | Cu | Nb + Ta |
| Wire W1 | JIS Z3317 | 0.06 | 0.54 | 1.08 | 0.01 | 0.01 | 1.39 | — | 0.01 | — | 96.10 | 0.56 | 0.26 | — |
| | G52A-1CM3 | | | | | | | | | | | | | |
| Wire W2 | JIS Z3321 | 0.05 | 0.38 | 1.56 | 0.02 | 0.00 | 19.92 | 0.00 | 9.58 | 0.00 | 68.29 | 0.10 | 0.10 | |
| | YS308 | | | | | | | | | | | | | |
| Wire W3 | JIS Z3321 | 0.05 | 0.46 | 1.51 | 0.02 | 0.00 | 23.40 | — | 13.52 | — | 60.89 | 0.01 | 0.13 | — |
| | YS309 | | | | | | | | | | | | | |
| Wire W4 | JIS Z3321 | 0.08 | 0.47 | 1.54 | 0.02 | 0.00 | 26.96 | — | 21.21 | — | 49.46 | 0.14 | 0.12 | — |
| | YS310 | | | | | | | | | | | | | |
| Wire W5 | JIS Z3334 | 0.02 | 0.06 | 0.02 | 0.00 | 0.00 | 21.70 | 0.20 | 66.00 | — | 0.3 | 8.1 | — | 2.6 |
| | SNi6625 | | | | | | | | | | | | | |
| Wire W6 | JIS Z3334 | 0.03 | 0.01 | 0.15 | 0.00 | 0.00 | — | 2.35 | 96.30 | 0.93 | 0.06 | — | 0.01 | — |
| | SNi 2061 | | | | | | | | | | | | | |

TABLE 6

| | | | | | | | | Maximum | | Maximum hardness |
|---|---|---|---|---|---|---|---|---|---|---|
| | | | | | | Average | Maximum | hardness | Maximum hardness | of heat-affected |
| | | | | | | hardness | hardness | of heat- | of weld metal | zone to average |
| | | | | | | of lower | of weld | affected | to average hardness | hardness of |
| | | Kind of | Ni content | CTS | TSS | sheet | metal | zone | of lower sheet | lower sheet |
| No. | | wires | (mass %) | (kN) | (kN) | (HV) | (HV) | (HV) | (%) | (%) |
| Inventive | 3 | Wire W3 | 13.52 | 6.97 | 8.35 | 495 | 208 | 658 | 42 | 133 |
| Example | 4 | Wire W4 | 21.21 | 7.88 | 8.37 | 497 | 210 | 683 | 42 | 137 |
| | 5 | Wire W5 | 66.00 | 6.48 | 8.1 | 483 | 218 | 656 | 45 | 136 |
| | 6 | Wire W6 | 96.30 | 7.76 | 9.22 | 480 | 185 | 676 | 38 | 141 |
| Comparative | 2 | Wire W1 | 0.01 | 5.00 | 8.18 | 486 | 377 | 652 | 78 | 134 |
| Example | 3 | Wire W2 | 9.58 | 4.12 | 6.76 | 482 | 411 | 675 | 85 | 140 |

As shown in Table 6 and FIG. 16, in Inventive Examples No. 3 to No. 6, joining was performed using wires (welding materials) W3 to W6 containing 13 mass % or more of Ni by the arc spot welding method for joining dissimilar materials according to the present invention. Therefore, inexpensive arc welding equipment can be used, and a weld joint of dissimilar materials excellent in both the TSS and the CTS can be obtained. In particular, in Inventive Examples No. 3 and No. 4, the SUS wire having a low Ni content was used, so that the cost related to the wire also decreased as compared with Inventive Examples No. 5 and No. 6.

In all of Inventive Examples No. 3 to No. 6 and Comparative Examples No. 1 and No. 2, the 1500 MPa class medium-high-carbon high tensile steel sheet was used as the lower sheet, so that the maximum hardness of the heat-affected zone was 650 HV or more, and the maximum hardness of the heat-affected zone to the average hardness of the lower sheet was 130% or more. In Inventive Examples No. 3 to No. 6, the wire (welding material) containing 13 mass % or more of Ni was used, so that the maximum hardness of the weld metal was 50% or less with respect to the average hardness of the lower sheet, and was lower than those of Comparative Examples No. 2 and No. 3. Therefore, it is considered that the TSS and CTS of Inventive Examples No. 3 to No. 6 were superior to those of Comparative Examples.

On the other hand, in Comparative Example No. 2 in which joining was performed using the wire W1 having a Ni content of 0.01 mass % by the same welding method as that of Inventive Examples, the TSS was equivalent to those of Inventive Examples, but the CTS was remarkably decreased. In Comparative Example No. 3 in which the joining was performed using the wire W2 by the same welding method as in Inventive Examples, the Ni content was higher than that in the case of using the wire W1, but the structure of the weld metal was non-uniform, and the TSS and CTS were considered to be lower than those in Comparative Example No. 2.

### 3. Reference Example

Next, in a Reference Example, a steel sheet A having a tensile strength of about 0.6 GPa and a carbon (C) content of 0.06 mass % and a steel sheet B having a tensile strength of about 1.0 GPa and a carbon (C) content of 0.09 mass % were used as the lower sheet 20, the upper sheet 10 and the lower sheet 20 were joined to each other in the same manner as in Example 1 using the wire I and the wire III in Example 1, and the TSS and CTS were measured.

In the Reference Example, GA (Galvannealed Steel) 590DP (Dual Phase) was used as the steel sheet A, and GA 980DP was used as the steel sheet B.

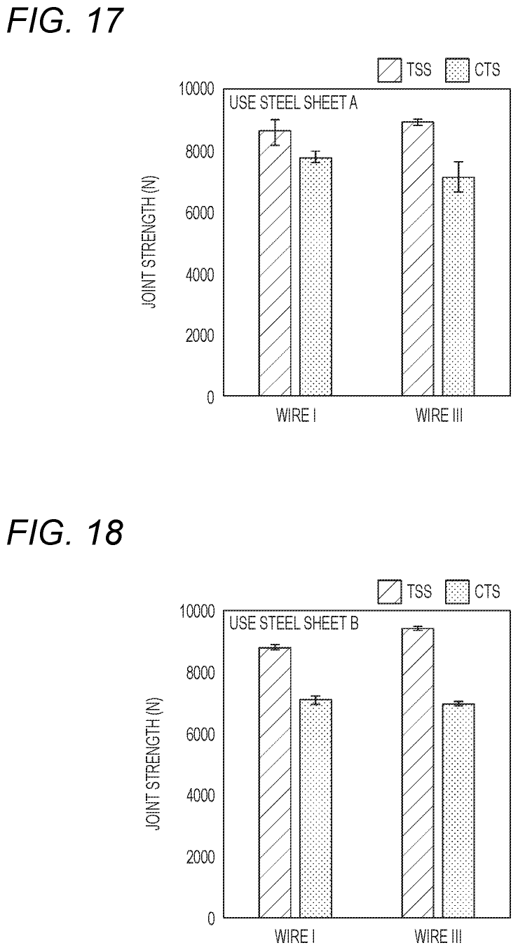

The chemical compositions of the wires I and III used are as shown in Table 2. FIG. 17 is a graph showing a relation between the kind of wires and the strength of the joint in the case where the steel sheet A was used, and FIG. 18 is a graph showing a relation between the kind of wires and the strength of the joint in the case where the steel sheet B was used.

As shown in FIG. 17, in the case where the steel sheet A of 0.6 GPa class was used, there was no large difference between the case of using the wire I containing no Ni and the case of the wire III containing 96.3 mass % of Ni, and good TSS and CTS could be obtained in both cases.

In addition, as shown in FIG. 18, even in the case where the steel sheet B of 1.0 GPa class was used, there was no large difference between the case of using the wire I and the case of using the wire III, and good TSS and CTS could be obtained in both cases.

These results showed that, in the case where a steel material having a tensile strength of less than 1180 MPa was used as the lower sheet, a good tensile strength could be obtained regardless of the Ni content of the welding material. That is, in the case where a steel sheet having a tensile strength of less than 1180 MPa is used as the lower sheet, it is not necessary to use a wire containing a predetermined amount of Ni as the welding material.

However, in the case where a steel sheet having a tensile strength of 1180 MPa or more is used as the lower sheet, the CTS is remarkably decreased if welding is performed using a wire containing no Ni. Therefore, it was shown that the arc spot welding method for joining dissimilar materials according to the present invention, which can prevent a decrease in the CTS, is remarkably effective.

Although various embodiments have been described above with reference to the drawings, it is needless to say that the present invention is not limited to such examples. It will be apparent to those skilled in the art that various alterations, modifications can be conceived within the scope of the claims, and it should be understood that they also justifiably belong to the technical scope of the present invention. Each component in the embodiments described above may be combined freely in the range without deviating from the spirit of the present invention.

The present application is based on Japanese Patent Application No. 2021-035718 filed on Mar. 5, 2021 and Japanese Patent Application No. 2022-004685 filed on Jan. 14, 2022, the contents of which are incorporated herein by reference.

### REFERENCE SIGNS LIST

1 weld joint of dissimilar materials
10 upper sheet (first sheet)
11 hole
20 lower sheet (second sheet)
30 joining auxiliary member
31 insertion portion
32 non-insertion portion
33 hollow portion
40 weld metal
41 interface portion (bond)
45 HAZ
50 welding wire (welding material)

1. An arc spot welding method for joining dissimilar materials, in which a first sheet made of an Al-based material or an Mg-based material and a second sheet made of ultra-high tensile steel having a tensile strength of 1180 MPa or more are joined, the arc spot welding method comprising:
forming a hole in the first sheet;
overlapping the first sheet and the second sheet;
inserting a joining auxiliary member made of steel, in which a hollow portion penetrating in a sheet thickness direction of the first sheet and the second sheet is formed, into the hole provided in the first sheet; and
joining the first sheet and the second sheet via the joining auxiliary member by using a welding material containing 13 mass % or more of Ni,
wherein the joining the first sheet and the second sheet is melting the second sheet and the joining auxiliary member and melting the welding material to fill the hollow portion of the joining auxiliary member with weld metal.

2. The arc spot welding method for joining dissimilar materials according to claim 1, wherein in the joining the first sheet and the second sheet, the weld metal is melted into the second sheet until a state where a back bead appears.

3. The arc spot welding method for joining dissimilar materials according to claim 1, wherein the joining auxiliary member has a stepped outer shape having an insertion portion and a non-insertion portion, and the hollow portion is formed in a manner of penetrating the insertion portion and the non-insertion portion.

4. The arc spot welding method for joining dissimilar materials according to claim 1, wherein in the joining the first sheet and the second sheet, any one of the following welding methods (a) to (e) is used:
(a) a gas-shielded arc welding method in which the welding material is used as a wire of a consumable electrode type;
(b) a non-gas arc welding method in which the welding material is used as a wire of a consumable electrode type;
(c) a gas tungsten arc welding method in which the welding material is used as a filler of a non-consumable electrode type;
(d) a plasma arc welding method in which the welding material is used as a filler of a non-consumable electrode type; and
(e) a coated arc welding method in which the welding material is used as a welding electrode of a consumable electrode type.

5. The arc spot welding method for joining dissimilar materials according to claim 3, wherein in the joining the first sheet and the second sheet, any one of the following welding methods (a) to (e) is used:
(a) a gas-shielded arc welding method in which the welding material is used as a wire of a consumable electrode type;
(b) a non-gas arc welding method in which the welding material is used as a wire of a consumable electrode type;
(c) a gas tungsten arc welding method in which the welding material is used as a filler of a non-consumable electrode type;
(d) a plasma arc welding method in which the welding material is used as a filler of a non-consumable electrode type; and
(e) a coated arc welding method in which the welding material is used as a welding electrode of a consumable electrode type.

6. A weld joint of dissimilar materials, which is joined by the arc spot welding method for joining dissimilar materials according to claim 1, the weld joint comprising:
a first sheet made of an Al-based material or an Mg-based material;
a second sheet made of ultra-high tensile steel having a tensile strength of 1180 MPa or more; and
a joint portion where the first sheet and the second sheet are joined,
wherein the first sheet has a hole facing a surface to overlap the second sheet, and
the joint portion includes
a joining auxiliary member made of steel, the joining auxiliary member being inserted into the hole provided in the first sheet and having a hollow portion penetrating in a direction orthogonal to the overlapping surface, and
a weld metal which includes a part of the joining auxiliary member and a part of the second sheet and with which the hollow portion of the joining auxiliary member is filled.

7. The weld joint of dissimilar materials according to claim 6,
wherein the second sheet has a heat-affected zone at a position adjacent to the joint portion,
a maximum hardness of the heat-affected zone is 130% or more with respect to an average hardness of an area of the second sheet excluding the heat-affected zone, and
a maximum hardness of the weld metal is 50% or less with respect to the average hardness.

8. The weld joint of dissimilar materials according to claim 6, wherein the joining auxiliary member has a stepped outer shape having an insertion portion and a non-insertion portion, and the insertion portion is inserted into the hole provided in the first sheet.
